(19) United States
(12) Patent Application Publication
(10) Pub. No.: US 2014/0261194 A1
(43) Pub. Date: Sep. 18, 2014

(54) INTERACTIVE TREAT-DISPENSING TOY FOR ANIMALS

(71) Applicant: PLANET VENTURES, INC., Portland, ME (US)

(72) Inventors: Jeff Cloutier, Westbrook, ME (US); Alex Fisher, Westbrook, ME (US)

(73) Assignee: PLANET VENTURES, INC., Portland, ME (US)

(21) Appl. No.: 13/798,647

(22) Filed: Mar. 13, 2013

(51) Int. Cl. A01K 5/00

(52) U.S. Cl. CPC A01K 5/00
USPC 119/51.01

(57) ABSTRACT

A treat-dispensing toy for an animal, particularly a dog, includes a hollow shell including an interior chamber and an interior structure disposed within the hollow shell to provide maze-like passageways in the shell. By rolling or tossing the shell about, the animal can work a treat along the passageways to an orifice in the shell, from which the animal can retrieve the treat. The shell can be made of a transparent or translucent material so that the animal can also see the movement of the treat within the shell.

### STATEMENT REGARDING FEDERALLY SPONSORED RESEARCH OR DEVELOPMENT

N/A

### BACKGROUND OF THE INVENTION

Many animals, particularly dogs, enjoy playing with toys. Some toys are known to include cavities in which an edible treat may be placed. The dog tries to remove the treat while playing with the toy.

### SUMMARY OF THE INVENTION

An interactive, treat-dispensing toy for an animal is provided.

In one embodiment, an interactive, treat-dispensing toy comprises a hollow shell comprising an exterior surface and an interior surface, the interior surface defining an interior chamber. An interior structure is fixedly disposed within the interior chamber of the hollow shell to provide maze-like passageways within the interior chamber. The hollow shell includes opposed or polar ends, with an aperture formed at a first end of the polar ends sized to allow a treat to pass through. The interior structure includes a partition disposed along a longitudinal plane passing through the polar ends of the shell. Baffles extend from opposed surfaces of the partition at staggered locations and in a step-like manner to define the maze-like passageways. One or more apertures in the partition allow the treat to pass from one half of the interior chamber to the other half.

By rolling or tossing the shell about, an animal can work the treat along the passageways to retrieve the treat through the orifice. The hollow shell can be transparent or translucent so that the animal can see the movement of the treat within the shell.

### DESCRIPTION OF THE DRAWINGS

The invention will be more fully understood from the following detailed description taken in conjunction with the accompanying drawings in which:

FIG. 1 is an isometric view of an embodiment of an interactive treat-dispensing toy according to the present invention;

FIG. 2 is a further isometric view of the toy of FIG. 1;

FIG. 3 is a further isometric view of the toy of FIG. 1;

FIG. 4 is a further isometric view of the toy of FIG. 1;

FIG. 5 is an isometric view of the shell of the toy of FIG. 1;

FIG. 6 is an end view of the shell of the toy of FIG. 5;

FIG. 7 is a side view of the shell of the toy of FIG. 5;

FIG. 8 is an isometric view of the interior structure of the toy of FIG. 1;

FIG. 9 is a top view of the interior structure of FIG. 8;

FIG. 10 is an end view of the interior structure of FIG. 8; and

FIG. 11 is a side view of the interior structure of FIG. 8.

### DETAILED DESCRIPTION OF THE INVENTION

FIGS. 1-11 illustrate an embodiment of a treat-dispensing toy 10 for an animal such as a dog. The treat-dispensing toy 10 includes a hollow shell 20 including an interior chamber 22 and a three-dimensional, maze-like, interior structure 30 disposed within the interior chamber 22 of the hollow shell. The interior structure 30 within the shell 20 forms maze-like passageways in which a treat, preferably an edible treat, can be placed. By rolling or tossing the shell 20 about, the animal can work the treat along the passageways to an orifice 24 in the shell 20, from which the animal can retrieve the treat. The shell can be made of a transparent or translucent material so that the animal can also see the movement of the treat within the shell.

In the embodiment illustrated, the hollow shell 20 has a spherical configuration including opposed or polar ends 26a, 26b on a central axis 27, and an interior surface 28 defining the interior chamber 22. The interior chamber also has a spherical shape. The orifice 24 is formed at a first end 26a of the polar ends of the shell to provide access to the interior chamber within the hollow shell. The orifice is sized to permit passage of an animal treat therethrough. An orifice 25 is formed at the second end 26b of the polar ends. As shown, the orifice 25 is smaller than orifice 24. A mandrel is inserted in the orifice 25 to support the shell 20 during manufacture. The smaller size does not generally permit a treat to pass through the finished toy. It will be appreciated that the orifice 25 could be larger, for example, the same diameter as orifice 24, to allow a treat to pass through if desired. Alternatively, no orifice could be provided at the polar end 26b, depending on the manufacturing method. The hollow shell can also have other configurations, such as elliptical, egg-shaped, football-shaped, box-like, or irregular. A generally rounded shape or a shape with rounded edges is suitable for allowing the animal to roll the toy about, although not required.

The three-dimensional maze-like interior structure 30 is disposed in the interior chamber 22 of the hollow shell 20. The maze-like interior structure includes a partition 40 having a planar configuration including opposed surfaces 42 and an outer periphery 44. The partition 40 is disposed within the interior chamber of the shell to lie along a longitudinal plane passing through the polar ends 26a, 26b of the shell 20, thereby dividing the interior chamber into two halves 46a, 46b. (See FIG. 2.)

The partition 40 can be fixedly mounted within the hollow shell 20 in any suitable manner. In the embodiment illustrated, a pair of channel elements 48 are formed on the interior surface of the shell at two or more locations along the longitudinal plane. (See FIGS. 6 and 7.) Two locations are shown, although more could be provided if desired. The channel elements 48 form a track in which the periphery 44 of the partition 40 fits, to thereby retain the partition within the shell. The partition can be mounted within the shell in any other suitable manner, such as, without limitation, with an adhesive, other mechanical fixturing elements, sonic welding, or the like.

In the embodiment shown, the outer periphery 44 of the partition 40 has two opposed convex sections 52 each having a contour of a portion of a circle complementary to an adjacent portion of the interior surface 28 of the shell 20. The periphery also includes two apertures 54a, 54b in the partition. One aperture 54a is located at the orifice 24 formed at the first polar end 26a. The second aperture 54b located on an opposite portion of the periphery 44 from the first aperture 54a. In the embodiment shown, each aperture 54a, 54b has a contour of a portion of a circle, although other contours, such as square or rectangular, could be provided. Both apertures provide passageways between the two halves 46a, 46b of the interior chamber 22, allowing the treat to pass from one side to the other side of the interior chamber. The aperture 54a at the first polar end 26a also allows the treat to pass through the orifice 24 out of the shell. The second aperture 54a could also be provided within an interior region of the partition 40 rather than on the periphery. Alternatively, a further aperture could also be provided within an interior region of the partition.

A plurality of baffles 60a, 60b extend from the opposed surfaces 42 of the partition 40 at staggered locations and in a step-like manner to define maze-like passageways. Each baffle extends orthogonally from one of the opposed surfaces 42 to an outward edge 62 adjacent to and having a contour corresponding to a portion of the interior surface 28 of the shell 20. Baffles 60a in a first group of baffles have a planar configuration extending in planes orthogonal to the central axis 27 through the polar ends 26a, 26b of the hollow shell. Baffles 60b in a second group of baffles have a planar configuration extending in planes parallel to the central axis 27. (See FIGS. 1, 8, and 11.)

The baffles 60a on one side of the opposed surfaces 42 are disposed parallel to each other and at staggered locations within each of the two halves of the interior chamber, to thereby provide steps defining the maze-like passageways. The baffles 60b on that same side of the opposed surfaces are disposed perpendicular to the baffles 60a to block passages through the maze-like interior structure. In some cases, a baffle 60a and a baffle 60b can be connected along adjacent edges 64 to form an angled baffle element.

In one embodiment, the plurality of baffles 60a, 60b are arranged symmetrically about the partition 40 on the two halves 46a, 46b of the interior chamber 22, although they need not be so symmetrically arranged.

The shell 20 can be comprised of a deformable material. Typically a plastic material is used. Suitable materials include a thermoplastic elastomer, particularly a synthetic rubber. Another suitable material is polypropylene, which is a harder material.

The three-dimensional maze-like interior structure 30 can be comprised of a material that is more rigid than the material comprising the hollow shell 20, providing further structural support to the shell, particularly if the shell is made from a deformable material. Typically, a plastic material is used for the interior structure. Suitable materials include a thermoplastic elastomer, particularly a synthetic rubber. Another suitable material is polypropylene. The interior structure 30 and the shell 20 can be formed of the same material.

At least the shell 20 and preferably also the maze-like interior structure 30 are comprised of an animal-safe material. The maze-like interior structure can be made in any suitable color. A bright color that can be easily seen and that may also contrast with the usual treat can be used, particularly when the material of the shell is translucent or transparent, so that the animal can see the treat's movement along the passages within the shell.

The toy can be manufactured in any suitable manner. In one embodiment, the shell 20 is molded from a deformable plastic material. The shell is held on a mandrel inserted through the smaller orifice 25 on the polar end 26b opposite the larger orifice 24. A tool is inserted into the larger orifice and expands the larger orifice, which is possible when the material of the shell is sufficiently deformable. The interior structure 30 is then placed into the interior chamber, seated in the channel elements 48. The tool is removed, and the orifice contracts, so that the interior structure is retained within the shell.

The toy can be manufactured in other ways, particularly if the shell is comprised of a hard or non-deformable material. For example, the shell 20 can be molded in two halves. The maze-like interior structure 30 is also molded and then placed within the two halves of the shell, within the channel elements 48. The halves are then joined along a longitudinally extending seam by, for example, an adhesive or sonic welding.

The invention is not to be limited by what has been particularly shown and described, except as indicated by the appended claims.

What is claimed is:

1. An interactive, treat-dispensing toy for an animal comprising:
a hollow shell comprising an exterior surface and an interior surface, the interior surface defining an interior chamber, and an interior structure fixedly disposed within the interior chamber of the hollow shell to provide maze-like passageways within the interior chamber,
wherein the hollow shell includes polar ends, and an orifice is formed at least at a first end of the polar ends of the shell, the orifice providing access to the interior chamber within the hollow shell, the orifice sized to permit passage of an animal treat therethrough; and
wherein the interior structure comprises:
a partition comprising a planar configuration including opposed surfaces and an outer periphery, the partition disposed within the interior chamber of the shell to lie along a longitudinal plane passing through the polar ends of the shell, the planar partition dividing the interior chamber into two halves;
the outer periphery having a contour corresponding to an adjacent portion of the interior surface of the shell, and two apertures in the partition, a first of the two apertures located at the orifice formed at the first polar end, the apertures providing passageways between the two halves of the interior chamber; and
a plurality of baffles extending from the opposed surfaces of the partition, each baffle having a planar configuration and extending orthogonally from one of the opposed surfaces to an outward edge adjacent to and having a contour corresponding to a portion of the interior surface of the shell, at least a first portion of the baffles on one side of the opposed surfaces disposed parallel to each other and at staggered locations within each of the two halves of the interior chamber.

2. The interactive, treat-dispensing toy of claim 1, wherein a further portion of the baffles on one side of the opposed surfaces are disposed perpendicular to the first portion of the baffles.

3. The interactive, treat-dispensing toy of claim 2, wherein at least one baffle of the first portion of the baffles and at least one baffle of the further portion of the baffles are connected along adjacent edges to form an angled baffle element.

4. The interactive, treat-dispensing toy of claim 1, wherein the plurality of baffles are arranged symmetrically about the partition on the two halves of the interior chamber.

5. The interactive, treat-dispensing toy of claim 1, wherein at least some of the baffles extend orthogonally from the opposed surfaces in planes orthogonal to a central axis extending through the polar ends of the hollow shell.

6. The interactive, treat-dispensing toy of claim 1, wherein at least some of the baffles extend orthogonally from the opposed surfaces in planes parallel to a central axis extending through the polar ends of the hollow shell.

7. The interactive, treat-dispensing toy of claim 1, wherein the second aperture in the partition is located on an opposite portion of the periphery of the partition from the first aperture.

8. The interactive, treat-dispensing toy of claim 1, wherein the hollow shell has a spherical configuration.

9. The interactive, treat-dispensing toy of claim 1, wherein the shell is comprised of a deformable plastic material.

10. The interactive, treat-dispensing toy of claim 1, wherein the three-dimensional structure is comprised of a material that is more rigid than the material comprising the hollow shell.

11. The interactive, treat-dispensing toy of claim 1, wherein the material of the shell is translucent or transparent.

12. The interactive, treat-dispensing toy of claim 1, wherein the partition of the interior structure is fixed within channel elements located on the interior surface of the shell.
